(19) United States
(12) Patent Application Publication
(10) Pub. No.: US 2025/0218209 A1
(43) Pub. Date: Jul. 3, 2025

(54) SYSTEMS AND METHODS FOR GENERATING PARTIAL BODY MODEL BASED ON DETECTED BODY PART IN AN IMAGE

(71) Applicant: Shanghai United Imaging Intelligence Co., Ltd., Shanghai (CN)

(72) Inventors: Abhishek Sharma, Boston, MA (US); Arun Innanje, Lexington, MA (US); Ziyan Wu, Lexington, MA (US); Terrence Chen, Lexington, MA (US); Fan Yang, Shanghai (CN); Yuchun Liu, Shanghai (CN)

(73) Assignee: Shanghai United Imaging Intelligence Co., Ltd., Shanghai (CN)

(21) Appl. No.: 18/400,140

(22) Filed: Dec. 29, 2023

(51) Int. Cl. G06V 40/10; G06T 17/20; G06V 10/42; G06V 10/44; G06V 10/764; G06V 10/82; G06V 20/70

(52) U.S. Cl. CPC G06V 40/10; G06T 17/20; G06V 10/42; G06V 10/44; G06V 10/764; G06V 10/82; G06V 20/70; G06T 2210/41; G06V 2201/03

(57) ABSTRACT

An apparatus may obtain an image that depicts a first human body part and determine, based on the image, a classification label and a plurality of vertices associated with the first human body part. The classification label may indicate a class of the first human body part and the plurality of vertices may correspond to points of the first human body part in a three-dimensional (3D) space. The determinations may be made using an artificial neural network that includes a self-attention module and a graph convolution module. The apparatus may generate a first 3D model representative of the first human body part based at least on the plurality of vertices associated with the first human body part. The self-attention module may determine global features of the image indicating an interrelationship of the plurality of vertices and the graph convolution module may refine the global features determined by the self-attention module.

### BACKGROUND

Certain medical procedures such as automatic patient positioning during medical scans (computed tomography (CT), magnetic resonance imaging (MRI), etc.) may require determining positional parameters associated with the patient. For example, the patient's pose in three-dimensional (3D) space (e.g., in a medical environment), 3D/2D keypoints on the patient's body, etc. may be determined by using external perception sensors like 3D RGB+D cameras, lidars, radars etc. However, in scenarios where multiple individuals or objects are present (e.g., in a medical CT scanning room), and an individual (e.g., a technician) or object may move in front of the patient and therefore occlude (e.g., partially) the scanning area of the patient, it may be difficult to accurately estimate a full 3D body model of the patient in order to, for example, estimate the position or motion of the patient and eliminate any motion related artifacts in a medical scan.

Template-based methods may be used to address this issue (e.g., partial occlusion of the patient's body) by using a template model of a complete human body as a reference to fit a partial view of the patient's body. The template may be deformed to match the shape of the visible body part of the patient and produce a complete body model. This approach may produce a consistent model topology, but it may not accurately capture the shape and fine details of the body part. Multi-view stereo reconstruction methods may also be used to address the aforementioned issue by using multiple views of the patient's body obtained from different sensors to produce a complete model. The partial models from different views may be combined and registered to produce a dense model. However, this approach can be sensitive to the particularities of the occlusions and may often require many views to produce a high-quality model. Accordingly, systems and methods capable of generating an accurate body model based on a detected body part in an image are desirable.

### SUMMARY

Described herein are systems, methods, and instrumentalities associated with detecting a human body part in an image and estimating a partial 3D body model of the human based on the detected body part. According to embodiments of the present disclosure, an apparatus may be configured to obtain (e.g., from at least one sensor inside a medical scanner room) an image that depicts a first human body part and determine, based on the image, a classification label and a plurality of vertices associated with the first human body part, wherein the classification label may indicate a class of the first human body part and the plurality of vertices may correspond to points of the first human body part in a three-dimensional (3D) space. The determination may be made using an artificial neural network that includes a self-attention module and a graph convolution module. A first 3D model (e.g., such as a 3D mesh) representative of the first human body part may be generated based at least on the plurality of vertices associated with the first human body part.

In some embodiments, the self-attention module may be configured to receive a representation of local features of the image and determine a plurality of global features of the image based on the local features, the plurality of global features indicating an interrelationship of the plurality of vertices.

In some embodiments, the graph convolution module may be configured to receive the representation of the local features and extract, from the local features, information that indicates local interactions of the plurality of vertices. The plurality of global features determined by the self-attention module may be refined with the extracted information.

In some embodiments, the artificial neural network may include a plurality of transformer layers and the graph convolution module may be located between two transformer layers of the artificial neural network.

In some embodiments, the graph convolution module may be configured to model the local interactions of the plurality of vertices via a graph that comprises nodes and edges, with each of the nodes corresponding to a respective vertex of the plurality of vertices, and with each of the edges connecting two nodes and representing an interaction between the vertices corresponding to the two nodes.

In some embodiments, the artificial neural network may further include a convolutional neural network configured to extract the local features from the image.

In some embodiments, the self-attention module may be configured to receive the representation of the local features as a sequence of tokens, project the sequence of tokens into a query vector, a key vector, and a value vector, and determine the plurality of global features based on the query vector, the key vector, and the value vector.

In some embodiments, the apparatus may be further configured to determine a classification label and a plurality of vertices associated with a second human body part, generate a second 3D model (e.g., a 3D mesh) that represents the second human body part based at least on the plurality of vertices associated with the second human body part, and further generate a full-body 3D model based at least on the first 3D model, the second 3D model, and the respective classification labels associated with the first human body part and the second human body part.

In some embodiments, the apparatus being configured to generate the full-body 3D model may include the apparatus being configured to up-sample the plurality of vertices associated with the first human body part and the plurality of vertices associated with the second human body part to a number of vertices required by a parametric human model, and generate the full-body 3D model based on the up-sampled number of vertices and the parametric human model.

In some embodiments, the apparatus may be further configured to determine a classification label probability that indicates of a likelihood that the first human body part belongs to the class indicated by the classification label, and to generate the first 3D model representative of the first human body part further based on a determination that the classification label probability is above a threshold value.

### BRIEF DESCRIPTION OF THE DRAWINGS

A more detailed understanding of the examples disclosed herein may be had from the following descriptions, given by way of example in conjunction with the accompanying drawings.

FIG. 1 shows a simplified block diagram of an example apparatus that may be used to perform the operations for detecting a body part in an image and estimating a partial 3D model based on the body part, according to some embodiments described herein.

FIG. 2 shows a simplified diagram of an image of a medical environment being analyzed to detect a body part in the image and estimate a partial 3D body model based on the detected body part, according to some embodiments described herein.

FIG. 3 shows a block diagram illustrating elements of an example artificial neural network (ANN) that includes a self-attention module and a graph convolution module, according to some embodiments described herein.

FIG. 4 shows a flow diagram illustrating how an artificial neural network (ANN) may be trained to estimate a partial body model based on a body part detected in an image, according to some embodiments described herein.

FIG. 5 shows a flow diagram illustrating an example method that may be performed for detecting a body part in the image and estimating a partial 3D body model based on the detected body part, according to some embodiments described herein.

FIG. 6A shows a flow diagram illustrating an example method for determining a plurality of global features of the image based on local features, wherein the plurality of global features indicates an interrelationship of the plurality of vertices, as described herein.

FIG. 6B shows a flow diagram illustrating an example method for extracting, from the local features, information that indicates local interactions of the plurality of vertices and refining the plurality of global features with the extracted information, according to some of the embodiments described herein.

FIG. 7 is a block diagram illustrating an apparatus in the example form of a computer system, within which a set or sequence of instructions may be executed to cause the machine to perform any one of the tasks discussed herein.

### DETAILED DESCRIPTION

The present disclosure is illustrated by way of example, and not by way of limitation, in the figures of the accompanying drawings.

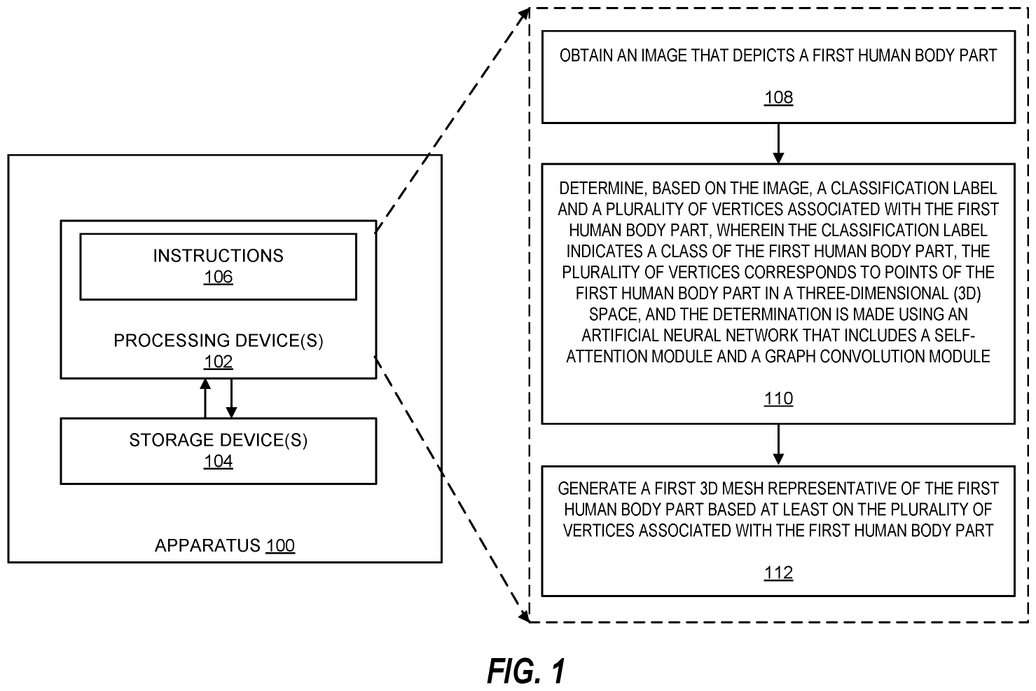

FIG. 1 shows a simplified block diagram of an example apparatus 100 that may be used to perform the operations (108-112) for detecting a body part in an image and estimating a 3D model (e.g., such as a 3D mesh) of the body part, according to some embodiments described herein.

Apparatus 100 may be a standalone computer system or a networked computing resource implemented in a computing cloud, and may include processing device(s) 102 and storage device(s) 104, where the storage device 104 may be communicatively coupled to processing device 102. Processing device(s) 102 may include one or more processors such as a central processing unit (CPU), a graphic processing unit (GPU), or an accelerator circuit. The storage device(s) 104 may include a memory device, a hard disc, and/or a cloud storage device connected to processing device 102 through a network interface card (not shown in FIG. 1). Processing device(s) 102 may be programmed to analyze an image (e.g., obtained from a visual sensor such as a camera, from storage device(s) 104 and/or some other storage device, etc.) to detect a human body part in the image and estimate a partial 3D body based on the detected human body part, as described herein, via instructions 106.

The processing device(s) 102 may execute instructions 106 and perform the following operations for detecting a human body part in the image and estimating a partial 3D body model based on the detected human body part. At operation 108, the processing device(s) 102 may obtain (e.g., from an image sensor inside a medical scanner room) an image that depicts a first human body part. In an example scenario, a medical imaging system may want to determine the movement of a patient in a medical environment (e.g., a scanning or surgery room). Multiple visual sensors may be placed in (or near) the medical environment in order to capture images (red-green-blue (RGB) images, depth images, and/or infrared (IR) images) of the environment (e.g., including multiple people such as the technician, a patient, etc.), which may then be analyzed to detect at least one body part of the patient (e.g., since full body is partially occluded by a technician or medical equipment). These images may be obtained by the processing device(s) 102 (e.g., obtained from the visual sensors directly or retrieved from storage device(s) 104) and processed as described below.

At operation 110, the processing device(s) 102 may determine, based on the image, a classification label and a plurality of vertices associated with the first human body part, wherein the classification label may indicate a class of the first human body part, the plurality of vertices may correspond to points of the first human body part in a three-dimensional (3D) space, and the determination may be made using an artificial neural network (ANN). For example, the whole human body may be divided into individual body parts that may be treated by the processing device(s) 102 as individual objects for object detection. Based on the operation at 110, the processing device(s) 102 may generate the following set of results [Class Label, (V1, V2 . . . . Vn)], where “Class Label” may represent the class of a body part, and (V1, V2 . . . . Vn) may represent n vertices (e.g., the 3D coordinates of n vertices) corresponding to n points of the body part in a 3D space. In examples, the processing device(s) may determine the same number of vertices (e.g., 100 vertices) for each detected body part. In examples, the classification label may include, or the processing device(s) 102 may additionally determine, a respective classification label probability for each classification label that may indicate the likelihood (e.g., prediction accuracy) that the body part belongs to the class indicated by the classification label. For example, the body may be separated into 15 parts: ‘Torso’, ‘Right Hand’, ‘Left Hand’, ‘Left Foot’, ‘Right Foot’, ‘Upper Leg Right’, ‘Upper Leg Left’, ‘Lower Leg Right’, ‘Lower Leg Left’, ‘Upper Arm Left’, ‘Upper Arm Right’, ‘Lower Arm Left’, ‘Lower Arm Right’, and ‘Head.’ Given an input image, the processing device(s) 102 may detect a body part in the image and indicate a class of the detected body via a classification label (e.g., “Right Hand”, “Left Hand,” etc.) and/or a classification label probability (e.g., 90% of being the “Right Hand” and 40% of being the “Left Hand”). The processing device(s) 102 may then generate a partial body model for the detected body part based on the classification label, the number of vertices determined for the body part, and/or a determination that the classification label probability is above a predetermined threshold value (e.g., the processing device(s) 102 may generate the partial body model only if the classification label probability is above 80%).

Treating each body part as an object and model estimation as object detection (e.g., instead of model generation) allows for estimation of the 3D model of each body part separately, which can be a more effective and accurate approach than estimating the entire body model at once when at least a part of the body is invisible in the input image (e.g., due to occlusion, ambiguity, etc.).

In examples, the artificial neural network (ANN) implemented by the processing device(s) 102 may adopt a transformer architecture comprising a self-attention module (e.g., a multi-head attention module) that may be configured to receive local features extracted from the image, determine global or contextual features of the image (e.g., which may indicate the dependencies of the vertices) based on the local features, and predict the classification label and the vertices (e.g., 3D coordinates of the vertices) described herein based on the global features. In examples, the ANN may include a convolutional neural network (CNN) such as a residual network (ResNet) or a Visual Geometry Group (VGG) network that may be configured to extract the local features. In examples, the ANN may include a plurality of transformer layers and a graph convolution module (e.g., comprising a plurality of graph convolution layers) that may be placed between two transformer layers of the ANN. The graph convolution module may take in the local features extracted by the aforementioned CNN (e.g., a VGG network or ResNet), along with positional embeddings and/or vertex queries determined by one or more self-attention layers, and learn the interdependencies (e.g., local interactions or patterns) of the local features based on the positional embeddings and/or vertex queries. The graph convolution module may model the learned interdependencies via a graph structure that the ANN may use to improve the accuracy of the vertex prediction.

In examples, the local features extracted from the image may be tokenized into an input token sequence. The self-attention module of the ANN may focus on different parts of the input token sequence simultaneously (e.g., with different attention heads) to capture diverse relationships (e.g., interdependencies) and patterns in the input sequence, and use the relationships and patterns to determine the classification label and 3D vertices associated with the detected body part. For instance, the self-attention module may be configured to transform the input token sequence representative of the features extracted from the image into Query (Q), Key (K), and Value (V) vectors for each attention head, and calculate attention weights for each head independently using the dot product of the Query and Key vectors. The self-attention module may further scale the attention scores by the square root of the dimension of the Key vectors to prevent gradients from becoming too small. The attention scores may then be passed through a SoftMax function to obtain a probability distribution over the input sequence, and the weighted sum of the Value vectors may give the output for each head. The self-attention module may concatenate the outputs of all the heads and transform them (e.g., linearly) to produce the final multi-head attention output. The number of heads used by the self-attention module may be a hyperparameter that can be adjusted based on the specific task (e.g., patient positioning, patient motion tracking, etc.) and the complexity of the body part(s) depicted in the image.

Still referring to FIG. 1, the processing device(s) 102 of apparatus 100 may, at operation 112, generate a first 3D model representative of the detected first human body part based at least on the plurality of vertices associated with the first human body part. For example, the first 3D model may be representative of the head of the patient (e.g., class label=“head” with a 90% probability) and may be generated based on the plurality (e.g., 100) of vertices associated with the head of the patient detected in the image. Using a 3D mesh as an example of the 3D model, the 3D mesh may be generated, for example, by connecting multiple vertices with edges to form a polygon (e.g., such as a triangle), connecting multiple polygons to form a surface, using multiple surfaces to determine a 3D shape, and applying texture and/or shading to the surfaces and/or shapes.

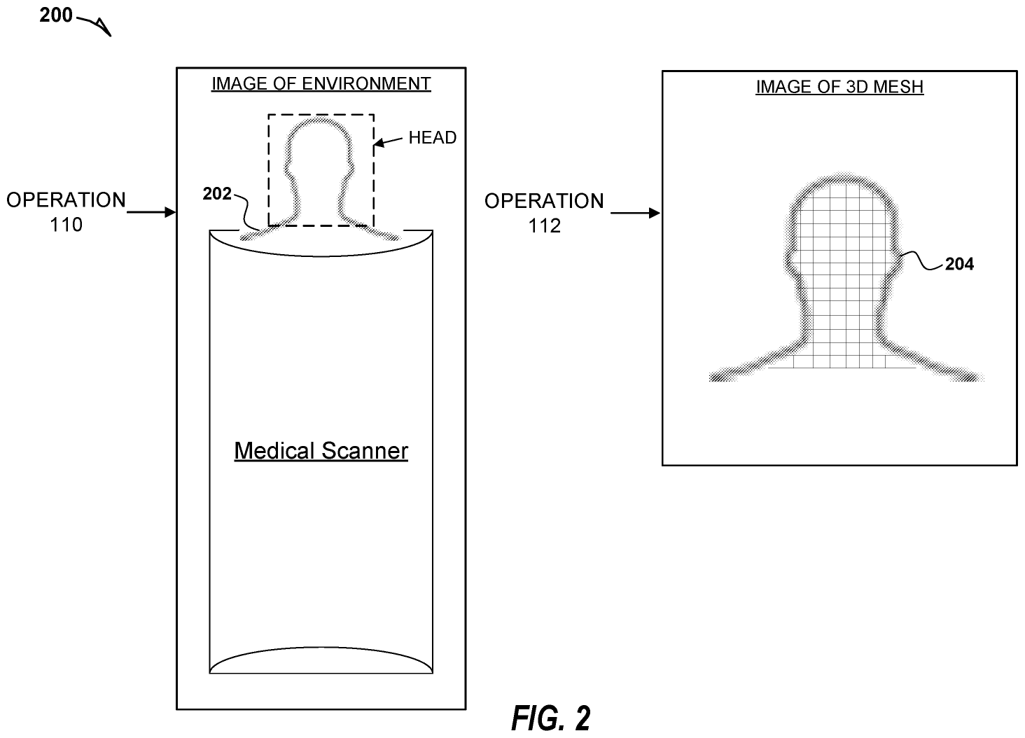

FIG. 2 shows an example of analyzing an image of a medical environment to detect a body part of a patient 202 in the image and estimate a partial 3D body model 204 based on the detected body part, according to some embodiments described herein.

As noted above with respect to FIG. 1, at operation 110 an image of a medical environment (e.g., medical scanner room) may be analyzed to determine a classification label and a plurality of vertices associated with a first human body part of the patient 202, wherein the classification label may indicate a class of the first human body part (e.g., head) and the plurality of vertices may correspond to points of the first human body part in a three-dimensional (3D) space. In some embodiments, the image of the environment may be a two-dimensional (2D) color image captured by a color sensor or a 2D depth image captured by a depth sensor. As noted above with respect to FIG. 1, at operation 112 a first 3D model 204 representative of the first human body part (e.g., the head) may be generated based at least on the plurality of vertices (e.g., 150 vertices) associated with the first human body part.

In some embodiments, a classification label and a plurality of vertices associated with a second human body part (e.g., a torso) of the patient 202 may be determined and a second 3D model that represents the second human body part may be generated based at least on the plurality of vertices associated with the second human body part. A full-body 3D model may then be generated based at least on the first 3D model, the second 3D model, and the respective classification labels associated with the first human body part and the second human body part (e.g., by combining the first 3D model and the second 3D model based on the respective classification labels associated with 3D models).

In some embodiments, the full-body 3D model may be generated by up-sampling the plurality of vertices associated with the first human body part and the plurality of vertices associated with the second human body part to a number of vertices required by a parametric human model (e.g., s Skinned Multi-Person Linear Model (SMPL) mesh topology, which has about 6890 vertices). The full-body 3D model may then be generated based on the up-sampled number of vertices and the parametric human model.

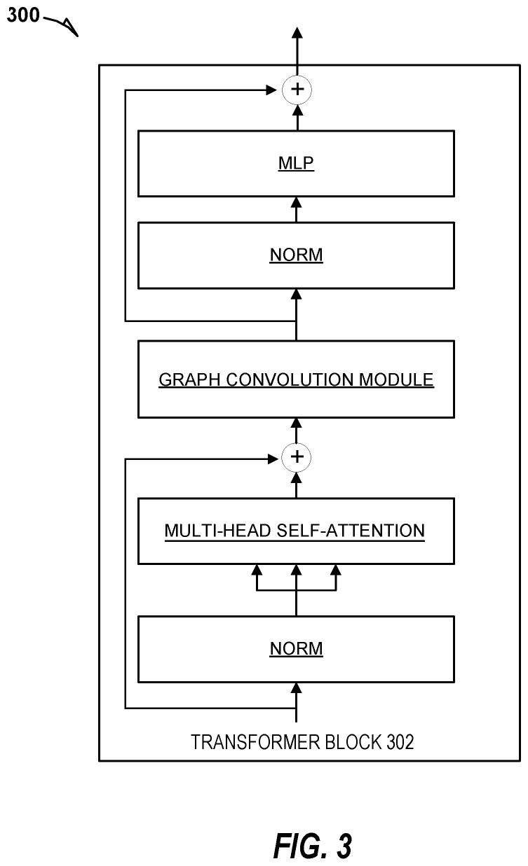

FIG. 3 shows a block diagram illustrating elements of an example artificial neural network (ANN) 300 that may be used to perform a partial human model recovery task according to some embodiments described herein.

The ANN 300 may include a self-attention module and a graph convolution module to capture both global and local image features for 3D human model reconstruction. The ANN 300 may include a stack of transformer blocks 302 with each block comprising one or more layer normalization modules (NORM), the self-attention module, the graph convolution module, and/or a multi-layer perceptron (MLP) module (e.g., configured to make the size of all input tokens consistent). As described herein, the ANN 300 may take an image as input and predict a classification label for a body part detected in the image and 3D vertices associated with the body part. The self-attention module may be configured to determine global or contextualized features of the image (e.g., which may indicate the interrelationship of the vertices) based on local image features that may be extracted using one or more convolutional layers. The contextualized features may be refined and/or reinforced by local interactions of the vertices encoded by the graphical convolution module. The refined and/or reinforced features may then be used to predict the classification label and the 3D coordinates of the vertices.

In examples, local image features extracted from an input image may be tokenized (e.g., the MLP module may be used to make the size of all input tokens consistent) and the self-attention module described herein (e.g., a multi-head self-attention module) may invoke several self-attention functions in parallel to learn a representation of contextual features based on the input tokens. For example, given an input token sequence X={x, x₂, . . . , xₙ}∈ [symbol] ^{n×d}, where d may represent a hidden size, the self-attention module may project the input sequence to queries Q), keys K, and values V by using trainable parameters {W_{Q}, W_{K}, W_{V}}∈ [symbol] ^{d×d}. This may be expressed as Q, K, V=XW_{Q}, W_{Q}, XW_{K}, XW_{V}∈ [symbol] ^{n×d}. The three feature representations Q, K, V may be split into h different subspaces, e.g., Q=[Q₁, Q₂, . . . , Qₕ] where Qⁱ∈R^{d/h}, so that self-attention may be performed for each subspace individually. Accordingly, for each subspace, the output Y^{h}={y₁^{h}, y₂^{h}, yₙ^{h}} may be computed as: yᵢ^{h}=Att(qᵢ^{h}, K^{h})V^{h}∈ [symbol] ^{n×d/h}, where Att(⋅) may denote the attention function that quantifies how semantically relevant a query qᵢ^{h} is to keys K^{h} by scaled dot-product and softmax. The output Y^{h}∈ [symbol] ^{n×d/h} from each subspace may then be concatenated to form the final output Y∈ [symbol] ^{n×d}.

The graph convolution module may be configured to receive the representation of the local features (e.g., X={x, x₂, . . . , xₙ}∈ [symbol] ^{n×d}) and extract, from the local features, information that indicates local interactions of the plurality of vertices. In some embodiments, the graph convolution module may include one or more graph convolution layers located between a set of transformer layers. The plurality of global features determined by the self-attention module (e.g., Y∈ [symbol] ^{n×d} from the self-attention module) may be refined with the information extracted by the graph convolution module to further capture fine details of the plurality of vertices.

The local interactions of the global features Y∈ [symbol] ^{n×d} generated by the self-attention module may then be improved by graph convolution as follows: Y′=GraphConv (Ā, Y; W_{G})=σ(ĀYW_{G}). Ā∈ [symbol] ^{n×n} may denote the adjacency matrix of a graph, W_{G} may denote the trainable parameters, and σ(⋅) may denote the activation function that gives the ANN 300 non-linearity (e.g., using a Gaussian Error Linear Unit (GeLu)). The graph convolution module may be configured to model the local interactions of the plurality of vertices via a graph that comprises nodes and edges, with each of the nodes corresponding to a respective vertex of the plurality of vertices, and with each of the edges connecting two nodes and representing an interaction between the vertices corresponding to the two nodes. In this way, the graph convolution module makes it possible to explicitly encode the graph structure within the ANN 300 and thereby improve spatial locality in the extracted features.

It should be noted that FIG. 3 only shows an example neural network structure that may be used to implement the functionality described herein. Other suitable network structures may also be used and the order or number of neural network layers may be adjusted based on the specific requirements of an application.

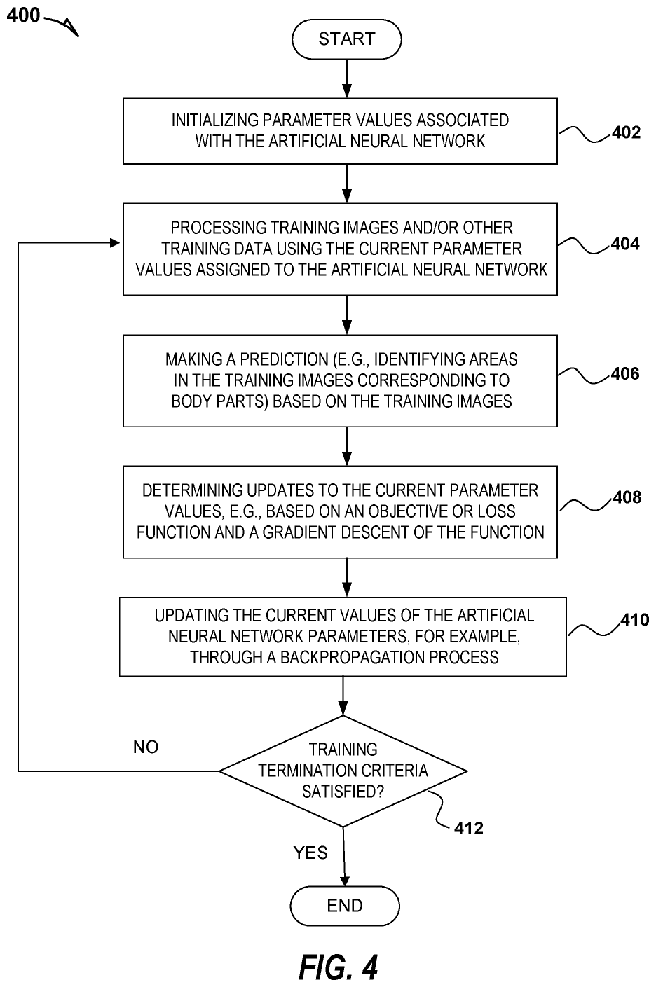

FIG. 4 shows a flow diagram 400 illustrating how an artificial neural network (ANN) may be trained to identify the image areas (e.g., “head” area of FIG. 2) corresponding to a body part of the patient in the image and/or vertices associated with the body part, according to some embodiments described herein.

The training process 400 may be performed by a system of one or more computers. At 402, the system may initialize the operating parameters of the ANN (e.g., weights associated with various layers of the artificial neural network 300 of FIG. 3). For example, the system may initialize the parameters based on samples from one or more probability distributions or parameter values associated with a similar ANN.

At 404, the system may process training images and/or other training data, such as the captured images of a technician and a patient inside a medical scanning room, using the current parameter values assigned to the ANN.

At 406, the system may make a prediction (e.g., identify areas in a training image corresponding to a detected body part of the patient and/or vertices associated with the detected body part) based on the processing of the training images.

At 408, the system may determine updates to the current parameter values associated with the ANN, e.g., based on an objective or loss function and a gradient descent of the function. As described herein, the objective or loss function may be designed to measure a difference between the prediction and a ground truth. The objective function may be implemented using, for example, mean squared errors, L1 norm, etc. associated with the prediction and/or the ground truth.

At 410, the system may update the current values of the ANN parameters, for example, by backpropagating the gradient descent of the loss function through the artificial neural network. The learning process may be an iterative process, and may include a forward propagation process to predict an output (e.g., prediction), and a backpropagation process to adjust parameters of the ANN based on a gradience descent associated with a calculated difference between the desired output (e.g., ground truth) and the predicted output.

At 412, the system may determine whether one or more training termination criteria are satisfied. For example, the system may determine that the training termination criteria are satisfied if the system has completed a pre-determined number of training iterations, or if the change in the value of the loss function between two training iterations falls below a predetermined threshold. If the determination at 412 is that the training termination criteria are not satisfied, the system may return to 404. If the determination at 412 is that the training termination criteria are satisfied, the system may end the training process 400.

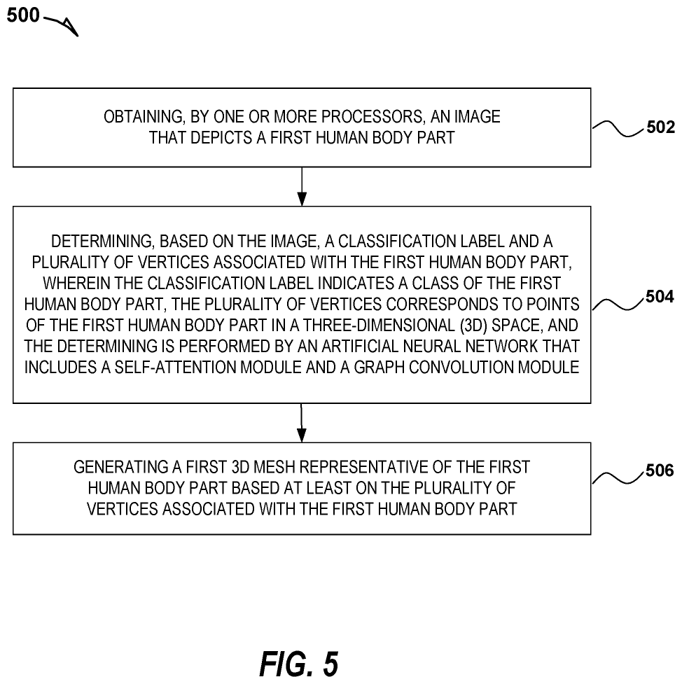

FIG. 5 shows a flow diagram illustrating an example method 500 that may be performed for detecting a body part in an image and estimating a 3D model based on the detected body part, according to some embodiments described herein.

As shown in FIG. 5, the method 500 may include obtaining (e.g., from an image sensor inside a medical scanner room) an image that depicts a first human body part at 502. As noted above, multiple visual sensors may be placed in (or near) the medical environment in order to capture images (RGB, depth, and/or IR) of the environment (e.g., including multiple people such as the technician, a patient, etc.), which may then be analyzed to detect at least one body part of the patient (e.g., since full body of patient may be partially occluded by a technician or medical equipment).

The method 500 may further include determining, based on the image, a classification label and a plurality of vertices associated with the first human body part at 504, wherein the classification label may indicate a class of the first human body part, the plurality of vertices may correspond to points of the first human body part in a three-dimensional (3D) space, and the determination may be made using an artificial neural network that includes a self-attention module and a graph convolution module. For detection of body parts, the output of the ANN may also include bounding boxes surrounding the detected body parts.

At 506, the method 500 may include generating a first 3D model representative of the first human body part based at least on the plurality of vertices associated with the first human body part. As noted above, the first 3D model may be representative of the head of the patient (e.g., class label=“head”) and may be generated based on the plurality (e.g., n=150) of vertices associated with the head of the patient detected in the image.

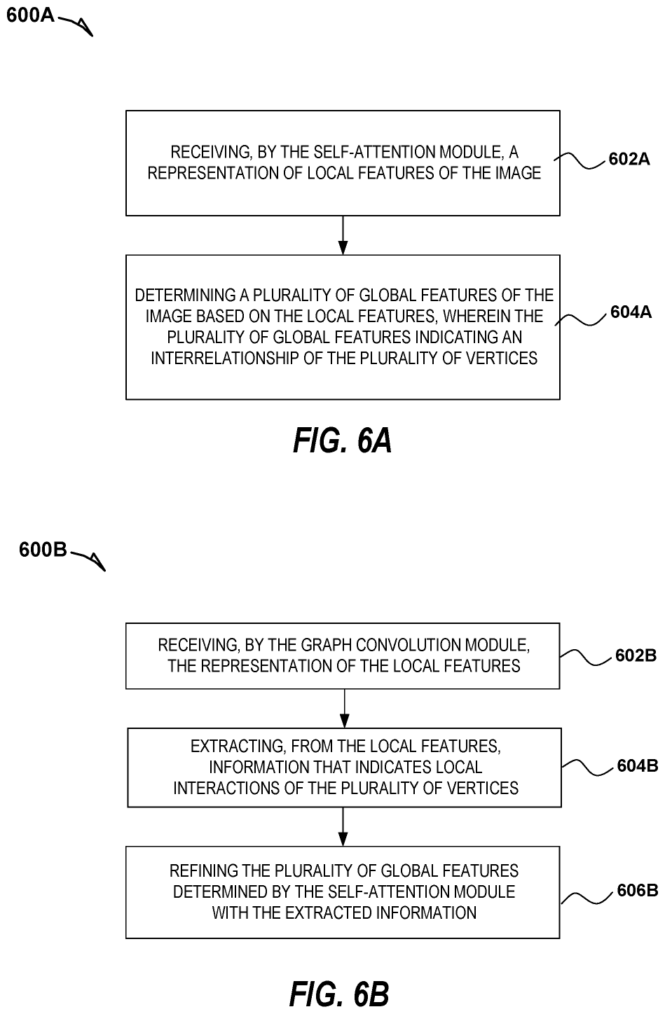

FIG. 6A shows a flow diagram illustrating an example method 600A for determining a plurality of global features (e.g., contextual features) of an image based on local features, wherein the plurality of global features may indicate the interrelationship of a plurality of vertices associated with a body part, as described herein. As shown in FIG. 6A, the method 600A may include receiving, by the self-attention module, a representation of local features of the image at 602A. As noted above, the local features may be extracted from the image using a plurality of convolutional layers and tokenized for input to the self-attention module as a sequence of tokens X={x, x₂, . . . , xₙ}∈ [symbol] ^{n×d}. The method 600A may further include determining, at 604A, a plurality of global features of the image based on the local features, wherein the plurality of global features may indicate an interrelationship of the plurality of vertices associated with a body part. As noted above, the local feature representations may be split into different subspaces so that self-attention may be performed for each subspace individually. Also as noted above, the output Y^{h}∈ [symbol] ^{n×d/h} from each subspace may then be concatenated to form the final output Y∈ [symbol] ^{n×d}.

FIG. 6B shows a flow diagram illustrating an example method 600B for extracting, from an image, information that may indicate the local interactions of a plurality of vertices associated with a body part and refining the global features determined by a self-attention module with the extracted information. As shown in FIG. 6B, the method 600B may include receiving, by a graph convolution module, a representation of the local features at 602B. As noted above, this representation may include of a sequence of tokens X={x, x₂, . . . , xₙ}∈ [symbol] ^{n×d}. At 604B, the method 600B may further include extracting, from the local features, information that indicates local interactions of the plurality of vertices. For example, the graph convolution module may model the local interactions between neighboring vertices based on a specified adjacency matrix (e.g., adjacency matrix of a graph). At 606B, the method 600B may further include refining the plurality of global features determined by the self-attention module with the extracted information. As noted above, the local interactions of the global features Y∈ [symbol] ^{n×d} generated by the self-attention module may be improved by graph convolutions as follows: Y′=GraphConv (Ā, Y; W_{G})=σ(ĀYW_{G}). Ā∈ [symbol] ^{n×n} may denote the adjacency matrix of a graph, W_{G} may denote the trainable parameters, and σ(⋅) may denote the activation function that gives the relevant neural network non-linearity (e.g., using the Gaussian Error Linear Unit (GeLu)).

For simplicity of explanation, the operations of the methods (e.g., performed by apparatus 100 of FIG. 1) are depicted and described herein with a specific order. It should be appreciated, however, that these operations may occur in various orders, concurrently, and/or with other operations not presented or described herein. Furthermore, it should be noted that not all operations that the apparatus is capable of performing are depicted in FIGS. 4, 5 and 6A-6B or described herein. It should also be noted that not all illustrated operations may be required to be performed.

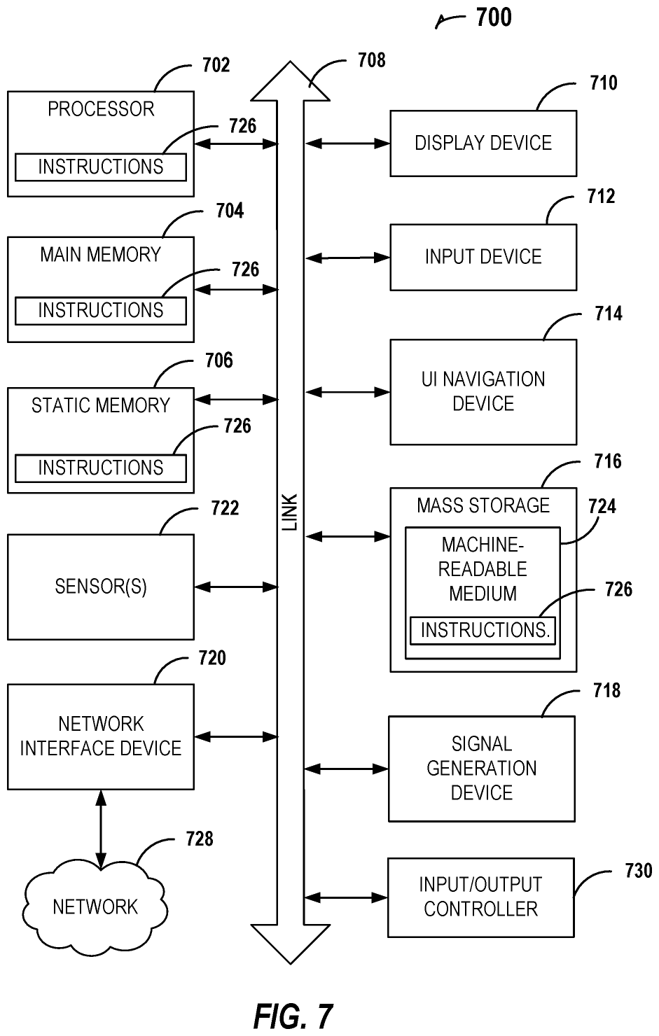

FIG. 7 is a block diagram illustrating an apparatus in the example form of a computer system 700, within which a set or sequence of instructions may be executed to cause the machine to perform any one of the methodologies discussed herein.

In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be an onboard vehicle system, wearable device, personal computer (PC), a tablet PC, a hybrid tablet, a personal digital assistant (PDA), a mobile telephone, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein (e.g., method 400 of FIG. 4, method 500 of FIG. 5 and methods 600A and 600B of FIGS. 6A-6B).

Example computer system 700 includes at least one processor 702 (e.g., a central processing unit (CPU), a graphics processing unit (GPU) or both, processor cores, compute nodes, etc.), a main memory 704 and a static memory 706, which communicate with each other via a link 708 (e.g., bus). The computer system 700 may further include a video display unit 710, an alphanumeric input device 712 (e.g., a keyboard), and a user interface (UI) navigation device 714 (e.g., a mouse). In one embodiment, the video display unit 710, input device 712 and UI navigation device 714 may be incorporated into a touch screen display. The computer system 700 may additionally include a storage device 716 (e.g., a drive unit), a signal generation device 718 (e.g., a speaker), a network interface device 720, and one or more sensors 722, such as a global positioning system (GPS) sensor, accelerometer, gyrometer, magnetometer, or other such sensor.

The storage device 716 includes a machine-readable medium 724 on which is stored one or more sets of data structures and instructions 726 (e.g., software) embodying or utilized by any one or more of the methodologies or functions described herein. The instructions 726 may also reside, completely or at least partially, within the main memory 704, static memory 706, and/or within the processor 702 during execution thereof by the computer system 700, with main memory 704, static memory 706, and the processor 702 comprising machine-readable media.

While the machine-readable medium 724 is illustrated in an example embodiment to be a single medium, the term “machine-readable medium” may include a single medium or multiple media (e.g., a centralized or distributed database, and/or associated caches and servers) that store the one or more instructions 726. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include volatile or non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 726 may further be transmitted or received over a communications network 728 using a transmission medium via the network interface device 720 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Wi-Fi, 3G, and 16G LTE/LTE-A or WiMAX networks). The term “transmission medium” shall be taken to include any intangible medium that is capable of storing, encoding, or carrying instructions for execution by the machine, and includes digital or analog signals or other intangible medium to facilitate communication of such software.

Example computer system 700 may also include an input/output controller 730 to receive input and output requests from at least one central processor 702, and then send device-specific control signals to the device they control. The input/output controller 730 may free at least one central processor 702 from having to deal with the details of controlling each separate kind of device.

The term “computer-readable storage medium” used herein may include any tangible medium that is capable of storing or encoding a set of instructions for execution by a computer that cause the computer to perform any one or more of the methods described herein. The term “computer-readable storage medium” used herein may include, but not be limited to, solid-state memories, optical media, and magnetic media.

The methods, components, and features described herein may be implemented by discrete hardware components or may be integrated in the functionality of other hardware components such as ASICS, FPGAs, DSPs or similar devices. In addition, the methods, components, and features may be implemented by firmware modules or functional circuitry within hardware devices. Further, the methods, components, and features may be implemented in any combination of hardware devices and computer program components, or in computer programs.

While this disclosure has been described in terms of certain embodiments and generally associated methods, alterations and permutations of the embodiments and methods will be apparent to those skilled in the art. Accordingly, the above description of example embodiments does not constrain this disclosure. Other changes, substitutions, and alterations are also possible without departing from the spirit and scope of this disclosure. In addition, unless specifically stated otherwise, discussions utilizing terms such as “analyzing,” “determining,” “enabling,” “identifying,” “modifying” or the like, refer to the actions and processes of a computer system, or similar electronic computing device, that manipulates and transforms data represented as physical (e.g., electronic) quantities within the computer system's registers and memories into other data represented as physical quantities within the computer system memories or other such information storage, transmission or display devices.

It is to be understood that the above description is intended to be illustrative, and not restrictive. Many other implementations will be apparent to those of skill in the art upon reading and understanding the above description. The scope of the disclosure should, therefore, be determined with reference to the appended claims, along with the full scope of equivalents to which such claims are entitled.

1. An apparatus, comprising:
one or more processors configured to:
obtain an image that depicts a first human body part;
determine, based on the image, a classification label and a plurality of vertices associated with the first human body part, wherein the classification label indicates a class of the first human body part, the plurality of vertices corresponds to points of the first human body part in a three-dimensional (3D) space, and the determination is made using an artificial neural network that includes a self-attention module and a graph convolution module; and
generate a first 3D model representative of the first human body part based at least on the plurality of vertices associated with the first human body part.

2. The apparatus of claim 1, wherein the self-attention module is configured to receive a representation of local features of the image and determine a plurality of global features of the image based on the local features, the plurality of global features indicating an interrelationship of the plurality of vertices.

3. The apparatus of claim 2, wherein the graph convolution module is configured to:
receive the representation of the local features;
extract, from the local features, information that indicates local interactions of the plurality of vertices; and
refine the plurality of global features determined by the self-attention module with the extracted information.

4. The apparatus of claim 3, wherein the artificial neural network includes a plurality of transformer layers and wherein the graph convolution module is located between two transformer layers of the artificial neural network.

5. The apparatus of claim 3, wherein the graph convolution module is configured to model the local interactions of the plurality of vertices via a graph that comprises nodes and edges, each of the nodes corresponding to a respective vertex of the plurality of vertices, each of the edges connecting two nodes and representing an interaction between the vertices corresponding to the two nodes.

6. The apparatus of claim 2, wherein the artificial neural network further includes a convolutional neural network configured to extract the local features from the image.

7. The apparatus of claim 2, wherein the self-attention module is configured to receive the representation of the local features as a sequence of tokens, project the sequence of tokens into a query vector, a key vector, and a value vector, and determine the plurality of global features based on the query vector, the key vector, and the value vector.

8. The apparatus of claim 1, wherein the one or more processors are further configured to determine a classification label and a plurality of vertices associated with a second human body part, generate a second 3D model that represents the second human body part based at least on the plurality of vertices associated with the second human body part, and further generate a full-body 3D model based at least on the first 3D model, the second 3D model, and the respective classification labels associated with the first human body part and the second human body part.

9. The apparatus of claim 8, wherein the one or more processors being configured to generate the full-body 3D model comprises the one or more processors being configured to up-sample the plurality of vertices associated with the first human body part and the plurality of vertices associated with the second human body part to a number of vertices required by a parametric human model, and generate the full-body 3D model based on the up-sampled number of vertices and the parametric human model.

10. The apparatus of claim 1, wherein the one or more processors are further configured to determine a classification label probability that indicates of a likelihood that the first human body part belongs to the class indicated by the classification label, and wherein the one or more processors are configured to generate the first 3D model representative of the first human body part further based on a determination that the classification label probability is above a threshold value.

11. A method for generating a partial body model, comprising:
obtaining an image that depicts a first human body part;
determining, based on the image, a classification label and a plurality of vertices associated with the first human body part, wherein the classification label indicates a class of the first human body part, the plurality of vertices corresponds to points of the first human body part in a three-dimensional (3D) space, and the determining is performed by an artificial neural network that includes a self-attention module and a graph convolution module; and
generating a first 3D model representative of the first human body part based at least on the plurality of vertices associated with the first human body part.

12. The method of claim 11, further comprising:
receiving, by the self-attention module, a representation of local features of the image; and
determining a plurality of global features of the image based on the local features, wherein the plurality of global features indicates an interrelationship of the plurality of vertices.

13. The method of claim 12, further comprising:
receiving, by the graph convolution module, the representation of the local features;
extracting, from the local features, information that indicates local interactions of the plurality of vertices; and
refining the plurality of global features determined by the self-attention module with the extracted information.

14. The method of claim 13, wherein the artificial neural network includes a plurality of transformer layers and wherein the graph convolution module is located between two transformer layers of the artificial neural network.

15. The method of claim 13, further comprising modeling, by the graph convolution module, the local interactions of the plurality of vertices via a graph that comprises nodes and edges, each of the nodes corresponding to a respective vertex of the plurality of vertices, each of the edges connecting two nodes and representing an interaction between the vertices corresponding to the two nodes.

16. The method of claim 12, wherein the artificial neural network further includes a convolutional neural network configured to extract the local features from the image.

17. The method of claim 12, further comprising:
receiving, by the self-attention module, the representation of the local features as a sequence of tokens;
projecting the sequence of tokens into a query vector, a key vector, and a value vector; and
determining the plurality of global features based on the query vector, the key vector, and the value vector.

18. The method of claim 11, further comprising:
determining a classification label and a plurality of vertices associated with a second human body part;
generating a second 3D model that represents the second human body part based at least on the plurality of vertices associated with the second human body part; and
generating a full-body 3D model based at least on the first 3D model, the second 3D model, and the respective classification labels associated with the first human body part and the second human body part.

19. The method of claim 18, further comprising:
generating the full-body 3D model includes up-sampling the plurality of vertices associated with the first human body part and the plurality of vertices associated with the second human body part to a number of vertices required by a parametric human model; and
generating the full-body 3D model based on the up-sampled number of vertices and the parametric human model.

20. The method of claim 11, further comprising determining a classification label probability that indicates of a likelihood that the first human body part belongs to the class indicated by the classification label, and wherein the first 3D model representative of the first human body part is generated further based on a determination that the classification label probability is above a threshold value.
